(19) United States
(12) Patent Application Publication
(10) Pub. No.: US 2016/0151233 A1
(43) Pub. Date: Jun. 2, 2016

(54) METHOD AND DEVICE FOR TREATING METABOLIC DISEASE

(71) Applicant: BFKW, LLC, Grand Rapids, MI (US)

(72) Inventors: Randal S. Baker, Grand Rapids, MI (US); James A. Foote, Ada, MI (US)

(21) Appl. No.: 15/019,497

(22) Filed: Feb. 9, 2016

Related U.S. Application Data
(63) Continuation-in-part of application No. PCT/US2014/051259, filed on Aug. 15, 2014.
(60) Provisional application No. 61/870,531, filed on Aug. 27, 2013.
(60) Provisional application No. 61/878,409, filed on Sep. 16, 2013.
(60) Provisional application No. 61/904,892, filed on Nov. 15, 2013.

(30) Foreign Application Priority Data
Aug. 15, 2014 (US) PCT/US2014/051259

(51) Int. Cl. A61H 9/00

(52) U.S. Cl. CPC A61H 9/0078; A61H 2201/5007

(57) ABSTRACT

A method of treating metabolic disease includes applying stress to a portion of the gastrointestinal tract of a patient diagnosed with metabolic disease to treat the metabolic disease. A metabolic disease treatment device includes a surface that is shaped to a portion of the gastrointestinal tract that is adapted to apply stress to the portion of the gastrointestinal tract. A control causes the surface to apply stress intermittently to the portion of the gastrointestinal tract in a manner that treats the metabolic disease without causing substantial loss of body mass.

### CROSS REFERENCE TO RELATED APPLICATIONS

This application is a continuation-in-part of International Patent Application No. PCT/US2014/051259, filed on Aug. 15, 2014, which claims priority from U.S. patent application Ser. No. 61/870,531 filed on Aug. 27, 2013; U.S. patent application Ser. No. 61/878,409, filed on Sep. 16, 2013, and U.S. patent application Ser. No. 61/904,892, filed on Nov. 15, 2013, the disclosures of which are hereby incorporated herein by reference in their entirety.

### BACKGROUND OF THE INVENTION

The present invention is directed to a method and device for treating metabolic disease, including, but not limited to, type I diabetes, type II diabetes, pre-diabetes, brittle diabetes, hyperglycemia, hypercholesterolemia, hypertension, and the like.

After bariatric surgery, most of the metabolic problems (diabetes, hypertension, and hyperlipidemia) resolve. Some of the cause for this is related to diet changes and weight loss; however, a significant part of the improvement is due to other factors, such as changes in operation of the gastrointestinal tract. It has been recognized that patients with the RYGB (gastric bypass) surgery would have improved diabetes even apart from diet and weight loss.

### SUMMARY OF THE INVENTION

The present invention is directed to a technique for treating metabolic disease. It is directed to causing a neurohormonal response by application of pressure, or other mechanical stress, to a portion of the gastro-intestinal tract and, in particular, to the cardiac portion of the upper stomach. It is believed that the application of stress/pressure to a portion of the gastrointestinal track may cause a neurohormonal response of the gut to increase motility and thereby decrease transit time of intraluminal content through a portion of the gastrointestinal track. In particular, intraluminal contents are delivered to the distal bowel faster, which is believed to improve metabolic disease. There are several potential agents for this improvement which may act alone or in combination. The enhanced release of gut hormones, including incretins, by the distal bowel may decrease insulin resistance. A neurohormonal response of the brain may positively influence glucose regulation. Other substances may include bile acids, whereby increased gut motility may cause the bile acids to get to the distal bowel faster and in greater quantity where they are believed to regulate or impact glucose homeostasis. The neurohormonal activity may affect other organs, such as the liver, and may impact production of glucagon in the pancreas. Intraluminal content includes bacteria, including bacteria that may be harmful to metabolism. If gut transit time is lengthened, there may be bacterial overgrowth. Thus, the increase in gut motility reduces bacterial overgrowth. There are some bacteria that may be beneficial to metabolism, whereby an increase in gut motility may help move the beneficial bacteria to the distal gut.

More specifically, it is believed that certain metabolic diseases, such as type 2 diabetes, are motility disorders in which the stomach and intestine no longer empties properly with obesity and that RYGB surgery restores motility. However, where diabetes is present without morbidly excess weight, such as mild obesity, then RYGB surgery is not indicated. It is also believed that certain metabolic diseases result from gut hormone changes. The gut hormones include incretins and they have a significant impact on the pancreas and peripheral tissue. Basically, incretins are supposed to work internally so that blood sugar levels do not spike, thus they work to prevent diabetes in normal people. One possible explanation is that the present invention treats metabolic disease by addressing failures of the brain-centered system or enhancing the release of gastrointestinal hormones, such as incretins, or both. It is believed that this is attributable to increased incretin secretion after eating. One such incretin called GLP-1 is released by the cells of the distal small bowel after eating and causes the pancreas to be more efficient with insulin release and causes the periphery to be more sensitive to insulin. The net result is a significant improvement in diabetes.

Incretins are a group of gastrointestinal hormones that cause an increase in the amount of insulin released from the beta cells of the islets of Langerhans. They also inhibit glucagon release from the alpha cells of the islets of Langerhans. They also cause peripheral tissue to be more sensitive to insulin. It is known that incretins are released from intraluminal contents when the contents reach the distal gut, such as the ileum, and travel through the bloodstream to the pancreas. It is believed that the release of incretins can be enhanced by the decrease in transit time of intraluminal contents through the stomach and small intestines on their path to the ileum and the rest of the distal bowel.

The brain also plays a key role in a two-system model of glucose regulation. It is now believed that, in addition to the islet-cell system, which responds to a rise in glucose levels by primarily releasing insulin, the brain-centered system enhances insulin-medicated glucose metabolism while also stimulating glucose effectiveness. The development of metabolic disease, such as type II diabetes, requires a failure of both the islet-cell system and the brain-centered system for regulating blood sugar levels.

While metabolic disease is often associated with obesity, and may be at least partially resolved by treating the obesity, there are individuals who have metabolic disease that are not obese or morbidly obese and may not even be overweight. The present invention provides a technique for treating metabolic disease that may be accomplished without a corresponding significant weight loss in the individual.

A method of treating metabolic disease in a patient having metabolic disease, according to an aspect of the invention, includes applying stress to a portion of the gastrointestinal tract of the patient having metabolic disease to treat the metabolic disease. The applying stress is believed to increase motility of intraluminal contents in a portion of the patient's gastrointestinal tract. The method may include diagnosing metabolic disease in the patient and wherein said applying stress is in response to the diagnosing.

The applying stress may include titrating the stress. The titrating the stress may include modulating the stress according to the patient's circadian rhythm. The modulating the stress according to the patient's circadian rhythm may include applying more stress during a sleeping portion of the patient's circadian rhythm than during an awake portion of the patient's circadian rhythm. The modulating stress according to the patient's circadian rhythm may include applying less stress during an eating portion of the patient's circadian rhythm than during a post-prandial portion of the patient's circadian rhythm. The applying stress may include applying stress to the cardiac portion of the stomach. The applying stress may include applying an outward pressure on a wall of the portion of the gastrointestinal tract.

A method of treating metabolic disease, according to an aspect of the invention, includes diagnosing a metabolic disease and excess body mass in the patient. A device is deployed that is adapted to increase gut motility if it is determined that the patient has metabolic disease. Gut motility created with the deployed device in the patent is increased to thereby treat the metabolic disease. The increased gut motility created with the deployed device is titrated to avoid excess body mass loss in the patient.

The titrating of the increased gut motility may include reducing the gut motility created with the deployed device in relation to activity of the patient. The activity of the patient may include eating activity. The titrating of the increased gut motility may include reducing the increase before and during the eating activity and increasing gut motility post-prandial. The activity may include the awake state of the patient. The titrating of the increased gut motility includes increasing the gut motility when the patient is expected to not be awake and reducing the increase when the patient is expected to be awake.

A method of treating metabolic disease, according to an aspect of the invention, includes diagnosing a metabolic disease and any excess body mass in the patient. A device is deployed that is adapted to apply stress to a portion of the gastrointestinal tract if it is determined that the patient has metabolic disease. Stress is applied with the deployed device to the gastrointestinal tract to thereby treat the metabolic disease. The stress applied with the deployed device is titrated to decrease body mass loss if the patient does not have excess body mass.

The applying stress may include applying an outward pressure on a wall of the portion of the gastrointestinal tract. Titrating the stress applied may include adjusting applied stress intermittently. Titrating stress applied may include adjusting applied stress according to the patient's circadian rhythm, such as by increasing applied stress during the sleeping portion of the patient's circadian rhythm and decreasing applied stress during the waking portion of the patient's circadian rhythm. The titrating stress applied according to the patient's circadian rhythm may include decreasing applied stress during the eating portion of the patient's circadian rhythm and increasing applied stress during post-prandial portions of the patient's circadian rhythm.

Stress may be applied to the cardiac portion of the stomach, such as by positioning a cardiac surface of a cardiac member against the cardiac portion of the stomach and applying stress to the cardiac portion of the stomach with the cardiac surface. The cardiac surface may be sized and shaped to the cardiac portion of the stomach and include an opening over the esophageal gastric junction for the passage of luminal contents through the opening. The titrating of the stress applied may include modulating the stress applied by the cardiac surface to the cardiac portion of the stomach.

The titrating of the stress may include adjusting the length of at least one elongated member connecting an esophageal member in the esophagus of the patient with the cardiac member. The cardiac member may have a body supporting the cardiac surface and the stress adjusted by positioning an expandable device between the body and the cardiac portion of the stomach and adjusting the expanded state of the expandable device. The expandable device may include a bladder and is adjusted by supplying a fluid to or withdrawing a fluid from the bladder. Another bladder may be included that is not between the body and the cardiac portion of the stomach with a pump that transfers a fluid between the bladders in order to adjust stress applied to the cardiac portion of the stomach. The cardiac member may have a modulus of rigidity that is adjustable, and the modulus of rigidity of the cardiac member is adjusted to adjust stress applied by the cardiac surface to the cardiac portion of the stomach. The cardiac member may include a plurality of moveable leaves defining the cardiac surface and the leaves moved to adjust the stress applied by the cardiac surface to the cardiac portion of the stomach. The cardiac member may have a body supporting the cardiac surface and the stress adjusted by positioning an electromagnet between the body and cardiac surface and controlling excitation of the electromagnet.

A control may be provided to control the applying of stress intermittently to the wall of the portion of the gastrointestinal tract. The control may include an external control member positioned external the patient and electromagnetically coupled with an internal control member positioned internal the patient. The external control member may be programmable with a program to vary the applying of stress to the cardiac portion of the stomach. The external control member may have a user input device to allow the patient to vary the applying of stress to the cardiac portion of the stomach.

A method of treating metabolic disease in a patient having metabolic disease, according to an aspect of the invention, includes applying stress to a portion of the gastrointestinal tract when the patient is likely not eating and decreasing the stress when the patient is likely eating or about to eat.

A method of treating metabolic disease in a patient having metabolic disease, according to an aspect of the invention, includes increasing gut motility in a patient having metabolic disease including applying stress to a portion of the GI tract of the patient, the increase in gut motility mitigating the metabolic disease. The metabolic disease may be type I diabetes, type II diabetes, pre-diabetes, brittle diabetes, hyperglycemia, hypercholesterolemia and/or hypertension.

A metabolic disease treatment device, according to an aspect of the invention, includes a surface that is shaped to a portion of the gastrointestinal tract to apply stress to the portion of the gastrointestinal tract. A control causes the surface to apply stress intermittently to the portion of the gastrointestinal tract in a manner that treats the metabolic disease without causing substantial loss of body mass.

The control may cause the surface to apply stress as a function of activity of the patient. The activity of the patient may include eating activity. The control may reduce the stress applied with the surface before and during the eating activity and increase the stress post-prandial. The control may increase the stress applied with the surface during sleeping activity. The control may cause the surface to apply stress according to the patient's circadian rhythm. The control may cause the surface to apply more stress during a sleeping portion of the patient's circadian rhythm and apply less stress during a waking portion of the patient's circadian rhythm. The control may cause the surface to reduce stress applied during an eating portion of the patient's circadian rhythm and increase the applied stress at a post-prandial portion of the patient's circadian rhythm.

The surface may have a size and shape of the cardiac portion of the stomach and include an opening over the esophageal gastric junction for the passage of esophageal content. The surface may be defined by a cardiac member having a body. An esophageal member may be sized to be positioned in the esophagus of the patient and a connector connecting the esophageal member with the cardiac member including at least one elongated member. The control may be adapted to cause the cardiac member to apply stress intermittently by adjusting a length of the elongated member(s).

An expandable device may be positioned between the body and the cardiac portion of the stomach and wherein the control causing the body to apply stress intermittently by adjusting the expanded state of the expandable device. The expandable device may have a bladder and the control adjusting the expanded state of the expandable device by supplying a fluid to or withdrawing a fluid from the bladder. Another bladder that is not between the body and the cardiac portion of the stomach may be included along with a pump. The pump transfers a fluid between the bladders in order to adjust stress applied by the cardiac portion of the stomach.

The control may include an external control member that is positioned external the patient and electromagnetically coupled with an internal control member that is positioned internal the patient. The external control member may be programmable with a program to vary the applying of stress to the cardiac portion of the stomach. The external control member may have a user input device to allow the patient to vary the applying of stress to the cardiac portion of the stomach.

These and other objects, advantages and features of this invention will become apparent upon review of the following specification in conjunction with the drawings.

### BRIEF DESCRIPTION OF THE DRAWINGS

FIG. 1 is a flow diagram of a method according to an aspect of the invention;

FIG. 2 is an illustration of a device according to another aspect of the invention deployed in a patient;

FIG. 3 is a detailed embodiment of a device; and

FIG. 4 is the same view as FIG. 3 of an alternative embodiment thereof.

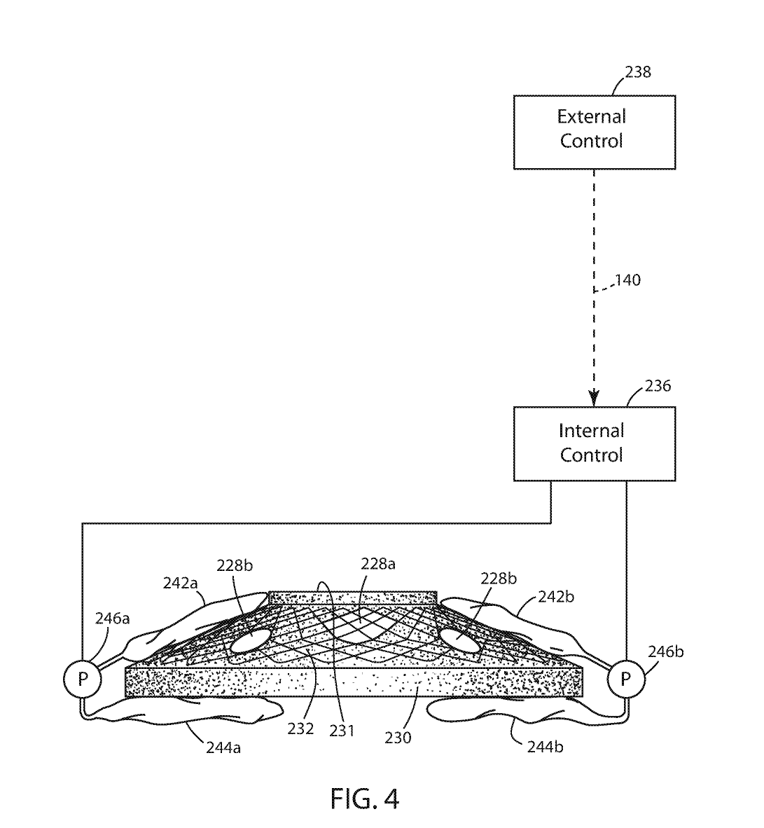

### DESCRIPTION OF THE PREFERRED EMBODIMENT

A device of the type disclosed in U.S. Pat. Nos. 7,846,174 and 8,529,431, the disclosures of which are hereby incorporated herein by reference, applies pressure or mechanical stress to the cardiac portion of the stomach. Such patents also disclose various techniques for such a device to provide adjustable pressure/stress, such as with a control that may or may not include a remote control button that causes a small pump to move fluid in and out of a reservoir. Various embodiments of such an adjustable device are further disclosed herein, such as wherein fluid under the cardiac portion would move to the top of the cardiac portion to increase pressure. This would allow immediate adjustability which, in turn, would allow titration of the pressure effect on the stomach.

An adjustable device could be set for low pressure during and immediately before meals and set for higher pressure at other times to minimize the weight loss effect. Titration could be affected by adjusting the pressure on a portion of the GI tract and the amount of time that the pressure is increased. This causes a neurohormonal response to regulate caloric intake and intestinal transit time and/or the brain's positive influence on glucose regulation thus impacting incretin response and glucose regulation. Therefore, it is possible to create an adjustable device for patients with diabetes both with and without excess body mass.

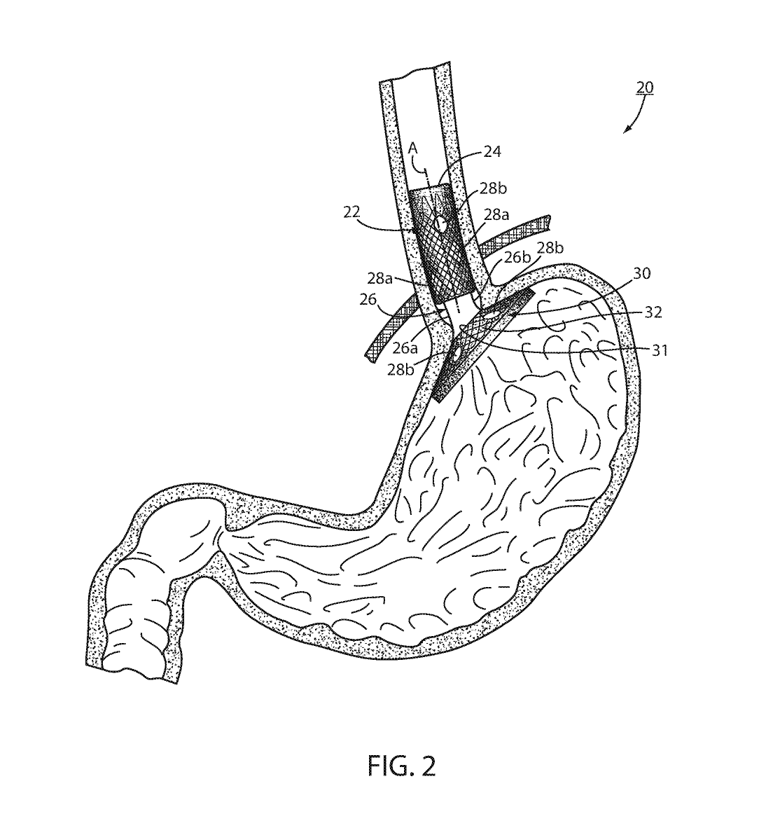

Referring now to the drawings and the illustrative embodiments depicted therein, a method 10 of treating metabolic disease includes determining at 11 that the patient has metabolic disease. If not, then the patient does not require a device (12) to be deployed for the treatment of a metabolic disease. If the patient is diagnosed with a metabolic disease at 11, a determination is made at 13 if the patient is also overweight, obese, or morbidly obese, thereby having excess body mass. If the patient has excess body mass, the patient may be fitted with a bariatric device at 14, such as a device 20 shown in FIG. 2. The patient may be fitted with a non-adjustable bariatric device or an adjustable bariatric device that is not adjustable using the techniques in the remainder of method 10 (16-19a).

If it is determined at 13 that the patient has a metabolic disease, but is not overweight, obese, or morbidly obese, a metabolic device is deployed at 15. The metabolic device has the ability to apply stress (such as an inward or outward pressure or force) to a portion of the gastrointestinal (GI) tract, such as to the cardiac portion of the stomach of a patient having the metabolic disease. The stress may also be applied to the distal esophagus, the pylorus, or other portion of the stomach, the duodenum, or other portion of the intestine. The stress may be a force or pressure to stimulate receptors, such as stretch receptors, baroreceptors, or the like. The stress may arise from placement of a surface that is positioned to interact with the peristaltic waves of the GI tract. The stress is delivered to create a neurohormonal response that may increase gut motility and thereby decrease transit time of intraluminal contents in a portion of the patient's gastrointestinal tract, thereby enhancing release of an incretin and/or causing the brain to positively influence glucose regulation. The stress may be applied by applying an outward/upward pressure on the cardiac portion of the stomach. If it is determined that the patient does not have excess body mass (i.e., overweight, obese, or morbidly obese), the stress is modulated or titrated to not cause significant further loss of body mass in the patient. For example, the stress may be applied intermittently, such as according to the patient's circadian rhythm.

It is determined at 16 whether the patient is either eating or preparing to eat. This may be determined based on an input from a remote control entered by the patient or from determining the eating portion of the patient's circadian rhythm. If so, the adjustable metabolic device is adjusted at 17 to either reduce or entirely remove stress or pressure to the cardiac portion of the stomach. This will reduce satiety caused by the metabolic device so that the patient will have an appetite and, therefore, eat well. The stress can then be applied post-prandial at 17a to again cause a neurohormonal response to the brain to increase gut motility by positively influencing glucose regulation and/or transit of intraluminal content to the gut to produce incretins and other gut hormones as a result of decreasing transit time of intraluminal contents to the distal bowel. The incretins cause the pancreas to be more efficient in secretion of insulin, as well as to cause the peripheral tissue to be more sensitive to insulin. A result of a decrease in gastrointestinal transit time is thus an increase in the amount and effectiveness of the insulin released and/or reducing the amount of glucagon released. Both of these responses to the neurohormonal affect applying mechanical stress to the gastro-intestinal tract, such as the cardiac portion of the stomach, should inure toward treatment of the metabolic disease of the patient without causing the patient to reduce intake.

If it is determined at 18 that the patient is asleep or likely to be asleep, the stress is either applied or increased at 19. Because the stress applied to the gastrointestinal tract is increased during the portion of the patient's circadian cycle when the patient is expected to be sleeping, such as by the patient operating a remote control device, the metabolic disease of the patient will be improved but the patient will not be experiencing weight loss. The patient is not expected to eat so the increase in satiety should not cause weight loss. The stress can then be reduced after sleep at 19a so that the patient has an appetite to eat.

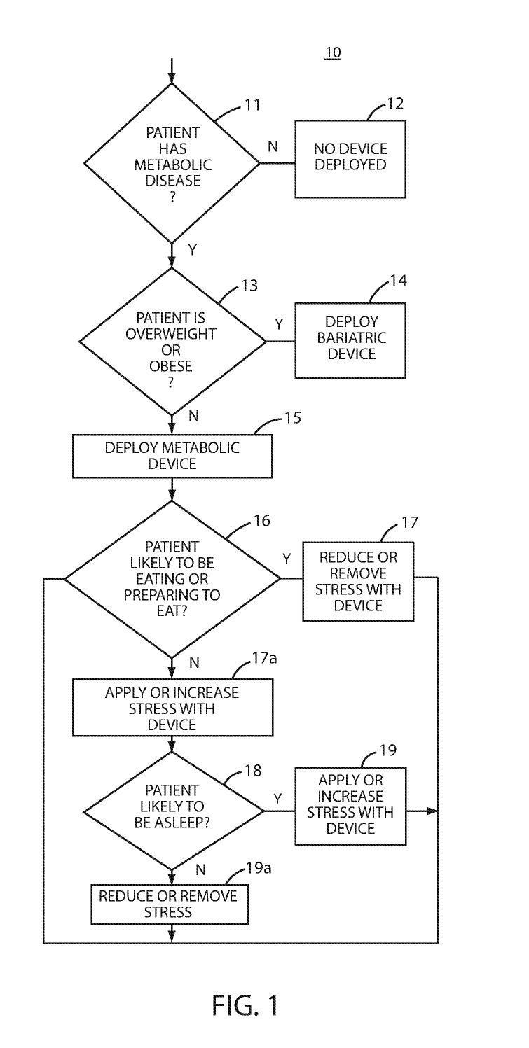

The bariatric device that is deployed at 14 may be device 20 that applies stress to the cardiac portion of the stomach generally continuously. Device 20 includes a cardiac member 30 that expands to the general size and shape of the cardiac region of the stomach (FIGS. 1-3) and an anchor to position cardiac member 30 against the cardiac portion of the stomach. Cardiac member 30 includes a body defining a cardiac surface 32 configured to apply stress, such as outward and upward pressure on the cardiac portion of the stomach and having a central opening 31 that aligns with the esophagus for the passage of intraluminal contents from the esophagus to the stomach. An example of such an anchor is an esophageal member 22 having a cylindrically shaped wall 24 that expands to the general size and shape of the esophagus. Members 22 and 30 are connected with a connector 26 that passes through the GE junction in a manner that does not inhibit operation of the GE junction. Esophageal wall 24 is defined by a support, such as a mesh, that is covered by a cover or coating, such as a silicone cover or coating that defines a proximal end portion and a distal end portion with respect to propagation of the peristaltic waves.

Esophageal wall 24 includes anchoring openings 28 between the end portions as disclosed in commonly assigned International Patent Application Publication No. WO 2012/162114 A1, the disclosure of which is hereby incorporated herein by reference. Such anchoring openings may be tissue ingrowth openings 28a defined by portions of the silicone cover being removed to allow mucosa to grow around the exposed mesh. Tissue ingrowth openings 28a are separated from each other by a section of the silicone cover in order to regulate tissue ingrowth to avoid strictures due to too much mucosa growing inside of the esophageal member. Anchoring openings 28 may be mucosal capture openings 28b in which mucosa is drawn into each opening and banded, such as using the technique disclosed in commonly assigned U.S. Patent Application Publication No. 2015/0182239 A1, the disclosure of which is hereby incorporated herein by reference in its entirety. Mucosal capture openings 28b are provided to immediately anchor device 20 until mucosa has had time to adequately grow into tissue ingrowth openings 28a, which occurs on the order of magnitude of a week. A plurality of mucosal capture openings 28a may be provided at a proximal end of esophageal member 22 or staggered along the length of the member. It should be understood that some mucosal capture is provided by tissue ingrowth openings 28a and some tissue ingrowth may occur in mucosal capture openings 28b. It should be understood that other anchoring techniques may be used such as sutures, fasteners, and the like.

Connector 26 connects esophageal member 22 and cardiac member 30 in a manner that does not interfere with the operation of the GE junction. In the illustrated embodiment, connector 26 is made up of two or more elongated tension members or struts 26a and 26b that are spaced apart roughly equal radial distances between the distal opening of esophageal member 22 and cardiac member 30. Struts 26a, 26b are shown oriented side-to-side in a frontal plane, but orientation is not critical and the device can be placed at a random radial orientation. Cardiac member 30 includes a generally planar disc made up of a Nitinol mesh covered with a bio-compatible material, such as silicone, that has an upper surface 32 that is configured to the size and shape of the cardiac region of the stomach or cardia. Central opening 31 in the disc aligns with the GE junction to allow the passage of esophageal luminal content, such as food, between the esophagus and the stomach.

Elongated tension members 26a, 26b allow anchored esophageal member 22 to pull cardiac member 30 via the tension members 26a, 26b in a manner that applies a stress, such as an outward and upward pressure against substantially all portions of the cardia surrounding the GE junction. In this manner, cardiac member 30 can apply stress on the cardiac portion of the stomach solely by the anchoring of esophageal member 22 in the esophagus by openings 28. This eliminates the need for the use of additional anchoring mechanisms. However, other anchoring mechanisms can be used, such as tissue ingrowth openings 28a formed in cardiac member 30 (not shown). Mucosal capture openings 28b may also be provided in cardiac member 30 in order to assist with temporary anchoring while mucosa is growing into tissue ingrowth openings 28a. Alternatively, or additionally, a tether may be passed between esophageal member 22 and cardiac member 30 through the esophageal and stomach walls to anchor device 20. While device 20 treats metabolic diseases set forth above, it also results in significant body loss. Other techniques for fixation and facilitating explantation of the bariatric device may be of the type disclosed in commonly assigned International Patent Application No. PCT/US15/67407 filed Dec. 22, 2015, entitled Fixation of Intraluminal Device, the disclosure of which is hereby incorporated herein by reference.

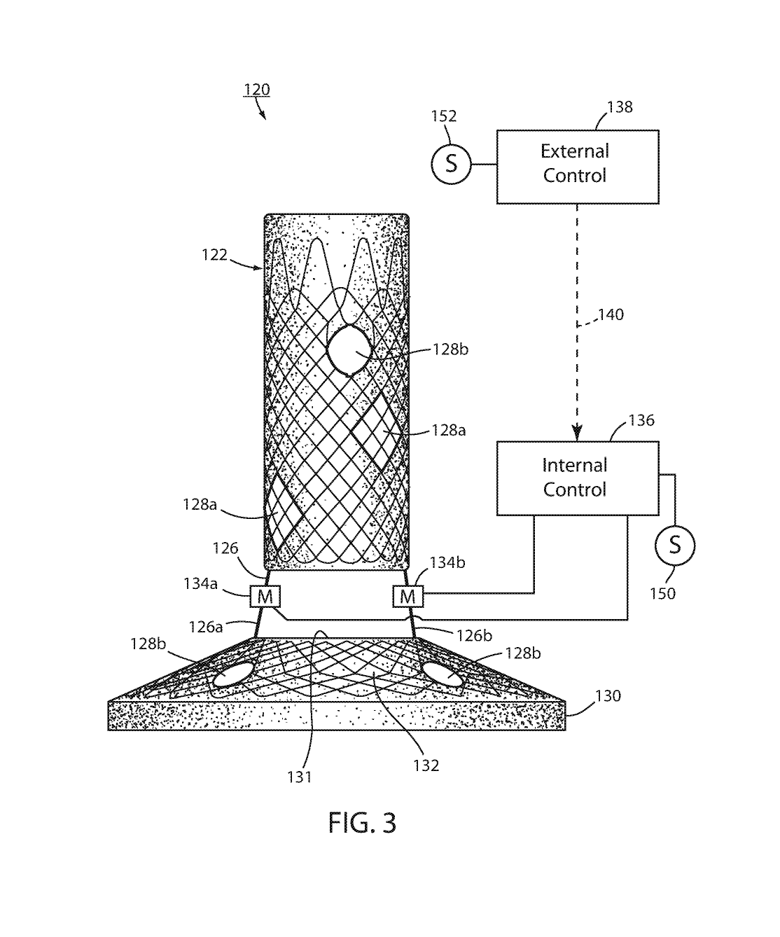

A metabolic device that is deployed at 15 that is capable of titrating stress applied to the gastro-intestinal tract may be a metabolic device 120 as is illustrated in FIG. 3. Device 120 includes a cardiac member 130 having an upper cardiac surface 132 that is adapted to be positioned against the cardiac portion of the stomach and sized and shaped to the cardiac portion of the stomach. Cardiac member 130 includes an opening 131 over the esophageal gastric junction for the passage of food. Cardiac surface 132 of member 130 is adapted to apply stress to the cardiac portion of the stomach thereby creating a neurohormonal response that decreases transit time of intraluminal contents in a portion of the patient's gastrointestinal tract and/or causes the brain to positively influence glucose regulation. Metabolic device 120 includes a control that causes the cardiac member to modulate or titrate the application of stress in order to not create significant loss of body mass in a patient who does not have extensive excess body mass yet produce a neurohormonal response in the gut to improve metabolic disease. The control may cause cardiac surface 132 of cardiac member 130 to apply stress intermittently in which it is believed to resolve metabolic disease and do so without substantial loss of body mass in the recipient. Stress may be increased or decreased by varying the absolute level of the stress, the integrated amount of stress applied over a particular amount of time, or both.

In particular, the control is adapted to cause cardiac member 130 to modulate or titrate applied stress according to the patient's activity, such as the circadian rhythm. While various patterns of activity may be selected from for a particular patient to use to determine when to apply, or increase, stress and when to withhold, or reduce, stress, in one embodiment, stress is applied or increased during times post-prandial when satiety caused by increase in applied stress will not interfere with the patient's consumption of calories since the patient is finished eating. When the patient is either eating or preparing to eat, stress may be decreased or removed in order to allow the patient to have a normal appetite and not produce satiety that would cause the patient is eat less. In another embodiment, stress may be applied or increased during the sleeping portion of the patient's circadian rhythm and withheld or decreased during the waking portion of the patient's circadian rhythm. This may involve withholding stress throughout normal waking hours and then increasing stress during sleep. This may not achieve as much effect as with adjusting stress as a function of the eating portion of the circadian rhythm because there may not be as much intraluminal content in the gastro-intestinal tract to respond to the increased stress. However, some beneficial effect should be achieved. Also, stress may be increased during an interval before the patient is preparing to eat in order to increase amount of incretins or other motility increasing hormones to condition the GI tract to process the carbohydrates from the upcoming meal. The stress could then be decreased immediately before and during the meal to allow the patient to develop an appetite for consuming the food.

Metabolic device 120 includes an esophageal member 122 having a cylindrical wall defining a central lumen that is adapted to be positioned in the esophagus of the patient and a connector 126 connecting esophageal member 122 with a cardiac member 130 with at least one, and illustrated as two, elongated members 126a, 126b. Cardiac member 130 includes a cardiac surface 132 for applying pressure to the cardiac portion of the stomach. Mucosal capture 128b and tissue ingrowth opening 128a anchor device 120 using principles previously described. A control made up of an internal control member 136 and external control member 138 is adapted to cause the cardiac member to apply or increase stress intermittently by adjusting the length of elongated members 126a, 126b. This may be accomplished by adjustment mechanisms 134a, 134b that are capable of paying out or retracting a portion of the respective elongated member. Internal control 136 may include an internal sensor 150 that is adapted to sense a chemical level in the stomach of the patient, such as glucose, or a hormone, such as incretin. Such chemical sensors are well known in the art. Thus, stress applied to the GI tract may be based on a pattern of hormone level in the patient, such as incretin. This provides an adaptive control scheme to allow device 120 to function according to the sensitivity of the regulatory system of the patient. Sensor 150 can sense the amount of regulatory hormone that is produced for a given amount of stress that is applied by the cardiac member to the cardiac portion of the stomach of the patient. Thus, if too large an increase in the amount of hormone level is produced for a given amount of applied stress, control 136 may reduce the amount of stress applied for a given situation to avoid a hypoglycemic condition. Conversely, if too small an increase in the amount of hormone level is produced for a given amount of applied stress, control 136 may increase the amount of stress applied for a given situation to reduce a hyperglycemic condition. Other examples will be apparent to the skilled artisan.

The external control member 138 is adapted to be positioned external the patient and electromagnetically coupled, such as with a wireless link 140 with internal control member 136 that is adapted to be positioned internal the patient. External member 138 may be programmable with a program to vary the applying of stress by cardiac member 130 to the cardiac portion of the stomach. External control member 138 may include a user input device (not shown) to allow the user to override the program or to otherwise control operation of device 120. Of course, the control may be entirely within the patient, but would be less accessible for adjustments to the program. External control member 138 may be a dedicated device or may be a known consumer device, such as a smart phone running application programs, or apps. An app could interrogate the user to input information on the carbohydrate content of the meal that either has just eaten or is about to eat so that internal control 136 can regulate stress levels post-prandial to a level that is appropriate to the amount of carbohydrates consumed. Alternatively, the app could receive from the user a list of the foods that the user has just eaten or is about to eat wherein the control can calculate the amount of simple and complex carbohydrates that have or will be consumed so that the control can regulate stress levels post-prandial according to the amount of carbohydrates that need to be processed. This helps to even out peaks and valleys in the glucose level of the patient.

External control 138 may also have a sensor 152. Sensor 152 may be responsive to a blood sample, such as from a finger prick, of the patient to obtain chemical readings, such as glucose or a hormone level. The chemical reading sensed by sensor 152 may be processed by a program in external control 138 and/or internal control 136 in order to attempt to avoid glucose spikes and depths in the patient. Also, external control 138 may serve as an external communication device, particularly if the external control is a smart phone, or the like. In this manner, readings obtained from sensor 150 and/or 152 can be communicated to an external analyst who could evaluate sensor readings and adjust stress levels applied to the patient according to achieved chemical levels detected by the sensor(s).

An alternative embodiment 220 of a metabolic device includes a cardiac member 230 that is generally the same as cardiac members 30, 130, except that it is not anchored using an esophageal member and it includes an expandable device 242a, 242b that is adapted to be positioned between the cardiac member 230 and the cardiac portion of the stomach. A control 236, 238, that is otherwise the same as control 136, 138 is adapted to cause cardiac member 230 to apply stress intermittently by adjusting the expanded state of said expandable device 242a, 242b in order to increase or decrease the total stress applied by the cardiac surface. In the illustrated embodiment, expandable devices 242a, 242b are each a bladder, and controls 236, 238 are adapted to adjust the expanded state of the expandable device by supplying a fluid to or withdrawing a fluid from the bladders. Whether bladders 242a, 242b are considered part of the cardiac surface or not, the inflation of the bladders causes an increase in the overall stress applied to the cardiac portion of the stomach, or cardia, while deflation of the bladders causes a decrease in the overall stress applied to the cardia. The expandable device may include another set of bladders 244a, 244b that are not between the cardiac member and the cardiac portion of the stomach and pumps 246a, 246b that transfers a fluid between each bladder 242a, 242b and respective bladders 244a, 244b in order to adjust stress applied by said cardiac member to the cardiac portion of the stomach. Alternatively, a subcutaneous port may be provided to allow fluid to be supplied to or withdrawn from bladders 242a, 242b. The fluid may be a gas, such as air, a liquid, such as saline solution, or a semi-liquid, such as a gel. Cardiac member 230 is anchored to the cardiac portion of the stomach, such as by mucosal capture openings 228b and tissue ingrowth openings 228a, of which only one is shown. Cardiac member 230 includes a collar 231 around an opening that provides for passage of the intraluminal contents from the esophagus to the stomach. The collar assists in aligning the opening with the gastro-esophageal junction.

Other techniques to modulate, or titrate, the application of stress are possible. For example, the cardiac member may have an adjustable modulus of rigidity. In this manner, the control can increase rigidity of the cardiac member to apply or increase the applied stress and decrease rigidity of the cardiac member to withhold or decrease the applied stress. The cardiac member may be a sponge-like material that is flaccid until a fluid is applied to the material with the material applying or increasing stress in the presence of a fluid. Alternatively, the cardiac member may be made of one or more leaves than can be positionally adjusted to make contact with the cardia or not make contact. Also, various arrangements of electromagnets may be energized to apply or increase stress and be de-energized to withhold or decrease stress, or vice versa. The electromagnets could be operated from an electrical source that is charged subcutaneously or inductively through the skin. The mucosal capture openings and/or tissue ingrowth openings may be attached to the body defining cardiac member 230 by an adjustable mounting portion, wherein the control increases or decreases the amount of stress applied by the cardiac member on the cardiac portion of the stomach.

The applying of stress, such as an inward or outward force or pressure, to a portion of the GI tract is believed to produce a neurohormonal response that may cause production of incretins by impacting emptying of the stomach, or gastric transit, and decrease in intestinal transit time of intraluminal content including bile acids which thereby reach the distal bowel sooner. The neurohormonal response may also cause the brain to positively influence glucose regulation. This enhanced production of incretins and/or improved glucose regulation produces an organic remedy for metabolic disease by increasing efficiency of the pancreatic secretion and sensitizing peripheral tissue to insulin. While the embodiments herein should result in a significant reduction in type II diabetes, it should also produce an improvement in type I diabetes. Also, it should improve brittle diabetes to no longer being brittle by decreasing the amount of insulin that is required to regulate glucose. This is believed to be a result of incretins sensitizing peripheral tissue to the effect of insulin. Also, the embodiments of the invention can be used to treat metabolic diseases, such as hypercholesterolemia, hyperglycemia, hypertension, and the like. Also, the application of stress to a portion of the gastrointestinal tract increases the metabolic rate thereby assisting in loss of body mass for patients who are overweight, obese, or morbidly obese. The various embodiments provide for titration of the metabolic and/or bariatric effect.

While the foregoing description describes several embodiments of the present invention, it will be understood by those skilled in the art that variations and modifications to these embodiments may be made without departing from the spirit and scope of the invention, as defined in the claims below. The present invention encompasses all combinations of various embodiments or aspects of the invention described herein. It is understood that any and all embodiments of the present invention may be taken in conjunction with any other embodiment to describe additional embodiments of the present invention. Furthermore, any elements of an embodiment may be combined with any and all other elements of any of the embodiments to describe additional embodiments.

The embodiments of the invention in which an exclusive property or privilege is claimed are defined as follows:

1. A method of treating metabolic disease in a patient having a metabolic disease, comprising:
diagnosing a metabolic disease and any excess body mass in the patient;
deploying a device that is adapted to apply stress to a portion of the gastrointestinal tract if it is determined that the patient has metabolic disease;
applying stress with the deployed device to the portion of the gastrointestinal tract to thereby treat the metabolic disease; and
titrating the stress applied with the deployed device to reduce body mass loss if the patient does not have significant excess body mass.

2. The method as claimed in claim 1 wherein said applying stress includes applying an outward pressure on a wall of the portion of the gastrointestinal tract.

3. The method as claimed in claim 2 wherein said titrating the stress applied includes adjusting applied stress intermittently.

4. The method as claimed in claim 3 wherein said titrating stress applied includes adjusting applied stress intermittently according to the patient's circadian rhythm.

5. The method as claimed in claim 4 wherein said adjusting applied stress intermittently according to the patient's circadian rhythm includes increasing applied stress during a sleeping portion of the patient's circadian rhythm and decreasing applied stress during a waking portion of the patient's circadian rhythm.

6. The method as claimed in claim 4 wherein said adjusting applied stress intermittently according to the patient's circadian rhythm includes decreasing applied stress during an eating portion of the patient's circadian rhythm and increasing applied stress post-prandial.

7. The method as claimed in claim 1 wherein said applying stress includes applying stress to the cardiac portion of the stomach wherein said titrating the stress applied includes adjusting the stress applied to the cardiac portion of the stomach.

8. The method as claimed in claim 7 wherein said applying stress to the cardiac portion of the stomach includes positioning a cardiac surface of a cardiac member against the cardiac portion of the stomach and applying stress to the cardiac portion of the stomach with said cardiac surface, said cardiac surface sized and shaped to the cardiac portion of the stomach and including an opening over the esophageal gastric junction for the passage of luminal contents through said opening.

9. The method as claimed in claim 8 wherein said modulating stress includes adjusting the length of at least one elongated member connecting an esophageal member in the esophagus of the patient with the cardiac member.

10. The method as claimed in 8 wherein said cardiac member has a body supporting said cardiac surface and wherein said adjusting stress includes positioning an expandable device between the body and the cardiac portion of the stomach and adjusting the expanded state of said expandable device.

11. The method as claimed in claim 10 wherein said expandable device comprises a bladder and wherein said adjusting the expanded state of said expandable device includes supplying a fluid to or withdrawing a fluid from said bladder.

12. The method as claimed in claim 11 including another bladder that is not between the body and the cardiac portion of the stomach and a pump, wherein said pump transfers a fluid between said bladder and said another bladder in order to adjust stress applied to the cardiac portion of the stomach.

13. The method as claimed in claim 8 wherein said cardiac member has a modulus of rigidity that is adjustable and including adjusting the modulus of rigidity of the cardiac member to adjust stress applied by said cardiac surface to the cardiac portion of the stomach.

14. The method as claimed in claim 8 wherein said cardiac member includes a plurality of moveable leaves defining said cardiac surface and including moving said leaves to adjust the stress applied by said cardiac surface to the cardiac portion of the stomach.

15. The method as claimed in claim 8 wherein said cardiac member has a body supporting said cardiac surface and wherein said adjusting stress includes positioning an electromagnet between said body and said cardiac surface and wherein said adjusting stress includes controlling excitation of said electromagnet.

16. The method as claimed in claim 3 including a control, said control adapted to control said adjusting of applied stress intermittently.

17. The method as claimed in claim 16 wherein said control includes an external control member that is adapted to be positioned external the patient and electromagnetically coupled with an internal control member that is adapted to be positioned internal the patient.

18. The method as claimed in claim 17 wherein at least one chosen from said internal control member and said external control member is programmable with a program to adjust the applied stress intermittently.

19. The method as claimed in claim 17 wherein said external control member has a user input device to allow the patient to adjust the applied stress intermittently.

20. The method as claimed in claim 16 wherein said control includes at least one sensor, said at least one sensor adapted to sense a chemical level in the patient and said control adjusts the applied stress as a function of chemical level sensed by said sensor.

21. The method as claimed in claim 8 including a control, said control adapted to control said adjusting of applied stress intermittently.

22. The method as claimed in claim 1 wherein said metabolic disease comprises at least one chosen from type I diabetes, type II diabetes, pre-diabetes, brittle diabetes, hyperglycemia, hypercholesterolemia and hypertension.

23. A method of treating metabolic disease in a patient having metabolic disease, comprising:
applying stress to a portion of the gastrointestinal tract of the patient when the patient is likely not be eating or preparing to eat; and
decreasing said stress when the patient is likely eating or preparing to eat.

24. The method as claimed in claim 23 wherein said metabolic disease comprises at least one chosen from type I diabetes, type II diabetes, pre-diabetes, brittle diabetes, hyperglycemia, hypercholesterolemia and hypertension.

25. A metabolic disease treatment device for treating metabolic disease in a patient, said device comprising:
a surface that is shaped to a portion of the gastrointestinal tract of the patient and adapted to apply stress to the portion of the gastrointestinal tract; and
a control that causes said surface to apply stress to the portion of the gastrointestinal tract in a manner that treats the metabolic disease of the patient without causing substantial loss of body mass.

26. The metabolic disease treatment device as claimed in claim 25 wherein said control adjusts the applied stress intermittently in order to treat the metabolic disease without causing substantial loss of patient body mass.

27. The metabolic disease treatment device as claimed in claim 25 wherein said control causes said surface to apply stress as a function of activity of the patient in order to treat the metabolic disease without causing substantial loss of patient body mass.

28. The metabolic disease treatment device as claimed in claim 27 wherein the activity of the patient comprises eating activity.

29. The metabolic disease treatment device as claimed in claim 28 wherein said control reduces the stress applied with said surface before and during the eating activity and increases the stress post-prandial.

30. The metabolic disease treatment device as claimed in claim 27 wherein said control increases the stress applied with said surface during sleeping activity.

31. The metabolic disease treatment device as claimed in claim 26 wherein said control causes said surface to apply stress according to the patient's circadian rhythm.

32. The metabolic disease treatment device as claimed in claim 31 wherein said control causes said surface to apply more stress during a sleeping portion of the patient's circadian rhythm and apply less stress during a waking portion of the patient's circadian rhythm.

33. The metabolic disease treatment device as claimed in claim 31 wherein said control causes said surface to reduce stress applied during an eating portion of the patient's circadian rhythm and increase the applied stress at a post-prandial portion of the patient's circadian rhythm.

34. The metabolic disease treatment device as claimed in claim 25 wherein said surface has a size and shape of the cardiac portion of the stomach and including an opening at the esophageal gastric junction for the passage of esophageal content through said opening and wherein said surface is defined by a cardiac member having a body.

35. The metabolic disease treatment device as claimed in claim 34 including an esophageal member that is adapted to be positioned in the esophagus of the patient and a connector connecting said esophageal member with the cardiac member with at least one elongated member and wherein said control causes said cardiac member to apply stress intermittently by adjusting a length of said at least one elongated member.

36. The metabolic disease treatment device as claimed in claim 34 including an expandable device positioned between the cardiac member body and the cardiac portion of the stomach and wherein said control causes said surface to apply stress intermittently by adjusting the expanded state of said expandable device.

37. The metabolic disease treatment device as claimed in claim 36 wherein said expandable device comprises a bladder and wherein said control adjusts the expanded state of said expandable device by supplying a fluid to or withdrawing a fluid from said bladder.

38. The metabolic disease treatment device as claimed in claim 37 wherein said fluid comprises a gas or a liquid.

39. The metabolic disease treatment device as claimed in claim 37 including another bladder that is not between the body and the cardiac portion of the stomach and a pump, wherein said pump transfers the fluid between said bladder and said another bladder in order to adjust stress applied to the cardiac portion of the stomach.

40. The metabolic disease treatment device as claimed in claim 25 wherein said control includes an external control member that is adapted to be positioned external the patient and electromagnetically coupled with an internal control member that is adapted to be positioned internal the patient.

41. The metabolic disease treatment device as claimed in claim 40 wherein at least one chosen from said internal control member and said external control member is programmable with a program to vary the applying of stress to the cardiac portion of the stomach.

42. The metabolic disease treatment device as claimed in claim 40 wherein said external control member has a user input device to allow the patient to vary the applying of stress to the cardiac portion of the stomach.

43. The metabolic disease treatment device as claimed in claim 34 wherein said cardiac member has a modulus of rigidity that is adjustable and wherein said control adjusts the modulus of rigidity of the cardiac member to adjust stress applied by said cardiac surface to the cardiac portion of the stomach.

44. The metabolic disease treatment device as claimed in claim 34 wherein said cardiac member includes a plurality of moveable leaves defining said cardiac surface and wherein said control is adapted to moving said leaves to adjust the stress applied by said cardiac surface to the cardiac portion of the stomach.

45. The metabolic disease treatment device as claimed in claim 34 wherein said cardiac member has a body supporting said cardiac surface and including an electromagnet between said body and said cardiac surface and wherein said control adjusts stress applied by said cardiac surface by controlling excitation of said electromagnet.

46. The metabolic disease treatment device as claimed in claim 33 wherein said control includes an external control member that is adapted to be positioned external the patient and electromagnetically coupled with an internal control member that is adapted to be positioned internal the patient.

47. The metabolic disease treatment device as claimed in claim 46 wherein said control includes at least one sensor, said at least one sensor adapted to sense a chemical level in the patient and said control adjusts the applied stress as a function of the chemical level sensed by said sensor.

48. The metabolic disease treatment device as claimed in claim 25 wherein said metabolic disease comprises at least one chosen from type I diabetes, type II diabetes, pre-diabetes, brittle diabetes, hyperglycemia, hypercholesterolemia and hypertension.
